(19) United States
(12) Patent Application Publication
(10) Pub. No.: US 2012/0268224 A1
(43) Pub. Date: Oct. 25, 2012

(54) MOUNTING UNIT FOR ELECTROMAGNETIC CONTACTOR AND CONNECTION STRUCTURE OF ELCTROMAGNETIC CONTACTOR USING THE SAME

(75) Inventors: Yasuhiro Naka, Kounosu-city (JP); Koji Okubo, Kounosu-city (JP); Kouetsu Takaya, Kounosu-city (JP); Kenji Suzuki, Kounosu-city (JP)

(73) Assignee: FUJI ELECTRIC FA COMPONENTS & SYSTEMS CO., LTD., Chuo-ku, Tokyo (JP)

(21) Appl. No.: 13/500,004

(22) PCT Filed: Sep. 13, 2010
(86) PCT No.: PCT/JP2010/005583

§ 371 Date: Jun. 4, 2012

(30) Foreign Application Priority Data
Jan. 14, 2010 (JP) 2010-005509

(51) Int. Cl. H01H 50/04

(52) U.S. Cl. 335/202

(57) ABSTRACT

A mounting unit for an electromagnetic contactor can prevent erroneous mounting of a non-mountable unit in a state in which a mountable unit is mounted on a case-side mounting portion, and a connection structure of an electromagnetic contactor uses the mounting unit. A mounting unit (3) for an electromagnetic contactor can be mounted on electromagnetic contactors (2a, 2b) having on a unit attaching portion (6b) a contactor-side mounting preventing portion (6f) that prevents mounting by engagement when a non-mountable unit, which cannot be mounted, is mounted. In the mounting unit (3), a unit main body (39) is provided with a mounting preventing transfer member (51) that forms a unit-side mounting preventing portion (54) that engages with a contactor-side mounting preventing portion (6f) when mounted on the electromagnetic contactors (2a, 2b) and prevents mounting of the non-mountable unit on a unit mounting portion (3g) onto which the non-mountable units (5a, 5b) are mounted.

### TECHNICAL FIELD

The present invention relates to a mounting unit for an electromagnetic contactor that is mounted on the electromagnetic contactor when desired by the user and to a connection structure of the electromagnetic contactor using the mounting unit.

### BACKGROUND ART

For example, the device described in Patent Document 1 is known as a mounting unit to be mounted on an electromagnetic contactor. This device has a pair of electromagnetic contactors having an excitation coil, a normally closed contact and a normally open contact, and also terminals thereof and are disposed in parallel to one another and an interlock block serving as a reversible unit that has connection terminals for connecting to the terminals of the aforementioned electromagnetic contactors and incorporates a wiring portion that performs interlock wiring between the connection terminals.

Patent Document 1: Japanese Patent Application No. 563-187523.

A mounting unit to be mounted on the electromagnetic contactor, in addition to the aforementioned reversible unit, is also known as an auxiliary contact unit that is provided with auxiliary circuit terminals as auxiliary terminals of the main circuit terminals of an electromagnetic contactor.

However, the electromagnetic contactor described in Patent Document 1 mentioned hereinabove is a device designed specifically for mounting only the reversible unit and is not supposed to be used for mounting other mounting units such as the auxiliary contact unit via the reversible unit.

In recent years, configurations in which the user himself stacks and mounts, as desired, a plurality of mounting units on an electromagnetic contactor have been considered. For example, a configuration has been considered in which a pair of electromagnetic contactors is arranged side by side, a reversible unit is head-on mounted between the two electromagnetic contactors, and an auxiliary contact unit is then mounted on the reversible unit.

However, since there are mountable auxiliary contact units and non-mountable auxiliary contact units depending on the configuration of the electromagnetic contactor, an erroneous mounting preventing mechanism is provided that allows the mountable auxiliary contact units to be mounted on the electromagnetic contactor and prevents the erroneous mounting of the non-mountable auxiliary contact units.

The erroneous mounting preventing mechanism is usually configured by forming a contactor-side engagement portion engaging with a unit-side engagement portion formed on the mountable unit on a unit mounting portion mounting the mounting unit of the electromagnetic contactor. The erroneous mounting preventing mechanism allows a mountable unit to be mounted on the unit mounting portion and prevents a non-mountable unit, which cannot be mounted, from being mounted on the unit mounting portion.

Where an electromagnetic contactor is provided with the above-described erroneous mounting preventing mechanism, when the mountable unit is mounted on the unit mounting portion of the electromagnetic contactor, the mounting can be performed by contacting the mounting surfaces with one another, but when the non-mountable unit is mounted on the unit mounting portion of the electromagnetic contactor, mutual contact between the mounting portions is prevented and the erroneous mounting state can be easily determined.

However, the following unresolved problem is associated with the reversible unit to be mounted between the electromagnetic contactor and the auxiliary contact unit. Thus, the reversible unit is configured to be mountable on any electromagnetic contactor, regardless of the configuration of the electromagnetic contactor, and when the auxiliary contact unit is mounted on the reversible unit, individual engagement portions mating with the case-side engagement portion of the electromagnetic contactor and the engagement portion of the auxiliary contact unit should be formed on the reversible unit, and reversible units of at least two types, namely, a reversible unit mountable on the electromagnetic contactor and a reversible unit non-mountable on the electromagnetic contactor, should be formed.

### DISCLOSURE OF THE INVENTION

The present invention has been made with consideration of the above-mentioned unresolved problem associated with the abovementioned conventional example. The object of the present invention is to provide a mounting unit for an electromagnetic contactor such that if a mountable unit that can be mounted on the electromagnetic contactor and a non-mountable unit that cannot be mounted on the electromagnetic contactor are present, when the mountable unit is mounted between both units and the electromagnetic contactor, erroneous mounting of the non-mountable unit is prevented by the mountable unit of one type, and also to provide a connection structure of an electromagnetic contactor using such a mounting unit.

In order to attain the abovementioned object, one aspect of the present invention provides a mounting unit for an electromagnetic contactor that can be mounted on an electromagnetic contactor having a contactor-side mounting preventing portion on a unit mounting portion, for preventing a mounting and engaging when mounted a non-mountable unit, which cannot be mounted, wherein a unit main body comprises a mounting preventing transfer member forming a unit-side mounting preventing portion preventing the mounting of the non-mountable unit on the unit mounting portion mounting the non-mountable unit by engaging with the contactor-side mounting preventing portion when mounted on the electromagnetic contactor.

With such a configuration, in a state in which a mountable unit has been mounted on an electromagnetic contactor as desired by the user, since the unit-side mounting preventing portion has been formed at the unit mounting portion of the mountable unit by the mounting preventing transfer member, erroneous mounting of a non-mountable unit on the mountable unit can be prevented by providing only the mountable unit of one type.

In the mounting unit for an electromagnetic contactor according to another aspect of the present invention, the mounting preventing transfer member comprises a rod-shaped portion inserted into a through hole formed to pass through the unit main body in a mounting direction facing the contactor-side mounting preventing portion when mounted on the electromagnetic contactor and a fall-out preventing portion formed to protrude in an intermediate portion of the rod-shaped portion.

With such a configuration, since the mounting preventing transfer portion is movably provided at the unit main body, where the mounting preventing transfer member engages with the contactor-side mounting preventing portion formed at the unit mounting portion of the electromagnetic contactor, the unit-side mounting preventing portion identical to the contactor-side mounting preventing portion is formed at the unit mounting portion and erroneous mounting of the non-mountable unit on the unit mounting portion is prevented.

In the mounting unit for an electromagnetic contactor according to another aspect of the present invention, a connection hole is formed in at least one side portion of the unit attaching portion of the electromagnetic contactor, the contactor-side mounting preventing portion is formed close to the connection hole on the inner side thereof, a hook piece locking with the connection hole is formed to protrude in a portion for mounting on the electromagnetic contactor, the through hole is formed close to the hook piece on the inner side thereof, and a linking hole is formed outside of the through hole in the unit mounting portion.

With such a configuration, in the case in which a non-mountable unit is mounted on the unit mounting portion of the mounting unit for an electromagnetic contactor in a state after the mounting unit for electromagnetic contactors has been mounted on the unit mounting portion of the electromagnetic contactor, when the non-mountable unit is caused to move along the unit mounting portion in a state after the hook piece of the non-mountable unit has been locked to the linking hole of the unit mounting portion, the mounting preventing engagement portion formed at the unit mounting portion rapidly abuts on the non-mountable unit, a state with a tilted non-mountable unit is assumed, and the erroneous mounting state can be reliably visually identified.

In the mounting unit for an electromagnetic contactor according to another aspect of the present invention, the unit main body is mounted over a plurality of unit attaching portions of electromagnetic contactors disposed parallel to one another and incorporates an interlock mechanism prohibiting simultaneous loading of the electromagnetic contactors.

With such a configuration, since the mounting unit for an electromagnetic contactor is mounted over a plurality of unit mounting portions of electromagnetic contactors, it is possible to configure a reversible unit having an interlock mechanism that prohibits simultaneous loading of electromagnetic contactors.

The connection structure of an electromagnetic contactor according to an aspect of the present invention has at least an electromagnetic contactor, a mountable unit that can be mounted on a unit attaching portion of the electromagnetic contactor, and a non-mountable unit that cannot be mounted on the electromagnetic contactor, wherein a contactor-side mounting preventing portion preventing erroneous mounting of the non-mountable unit is formed at the unit attaching portion of the electromagnetic contactor; and the mountable unit has a mounting preventing transfer member forming a unit-side mounting preventing portion preventing a mounting of the non-mountable unit on the unit mounting portion mounting the non-mountable unit by engaging with the contactor-side mounting preventing portion.

With such a configuration, where the mounting preventing transfer member engages with the contactor-side mounting preventing portion in a state after the mountable unit has been mounted on the electromagnetic contactor, the unit-side mounting preventing portion is formed at the unit mounting portion of the mountable unit and mounting of the non-mountable unit can be prevented.

In accordance with the present invention, the mounting unit for an electromagnetic contactor is provided with the mounting preventing transfer member that engages with the contactor-side mounting preventing portion formed at the unit-side mounting portion of the electromagnetic contactor and forms the unit-side mounting preventing portion at the unit mounting portion. Therefore, by providing the mounting unit for an electromagnetic contactor of only one type, it is possible to form the unit-side mounting preventing portion corresponding to the contactor-side mounting preventing portion of the electromagnetic contactor and prevent reliably the mounting of a non-mountable unit that cannot be mounted on the electromagnetic contactor.

### BRIEF DESCRIPTION OF THE DRAWINGS

FIG. 1 is a perspective view illustrating an electromagnetic contactor device according to the present invention.

FIG. 2 is an exploded perspective view of the device shown in FIG. 1.

FIG. 3 is a cross-sectional view illustrating the electromagnetic contactor.

FIGS. 4(a) to 4(c) are plan views illustrating the operation of the reversible unit, wherein FIG. 4(a) shows the release state; FIG. 4(b) shows the left-side loading state; and FIG. 4(c) shows the right-side loading state.

FIG. 5 is a perspective view illustrating the state in which the reversible unit is mounted on a pair of electromagnetic contactors.

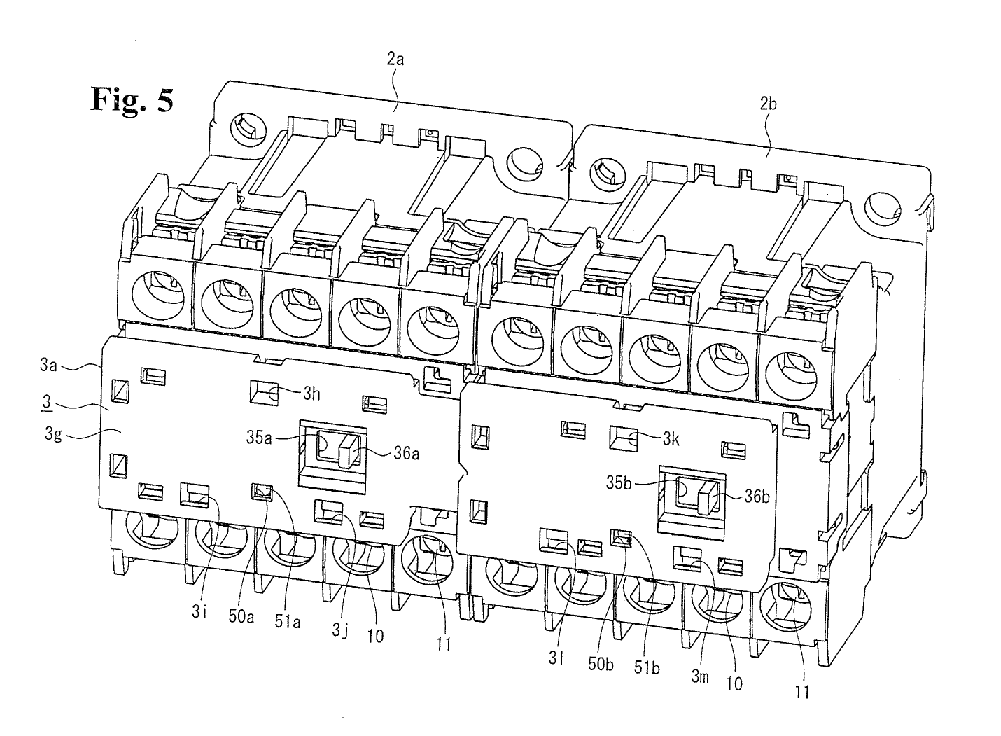

FIG. 6 is a perspective view illustrating the state before the reversible unit is mounted on a pair of electromagnetic contactors.

FIGS. 7(a) to 7(c) are diagrams showing a mounting relationship of the electromagnetic contactor and auxiliary contact unit.

FIGS. 8(a) to 8(c) are diagrams illustrating the state in which the auxiliary contact unit is mounted on the electromagnetic contactor, with the reversible unit being interposed therebetween.

FIG. 9 is a perspective view illustrating the position of the mounting preventing transfer member by a cross section.

FIG. 10 is a side view illustrating a portion of configuration in the state after the reversible unit and auxiliary contact unit have been mounted on the electromagnetic contactor by a cross section.

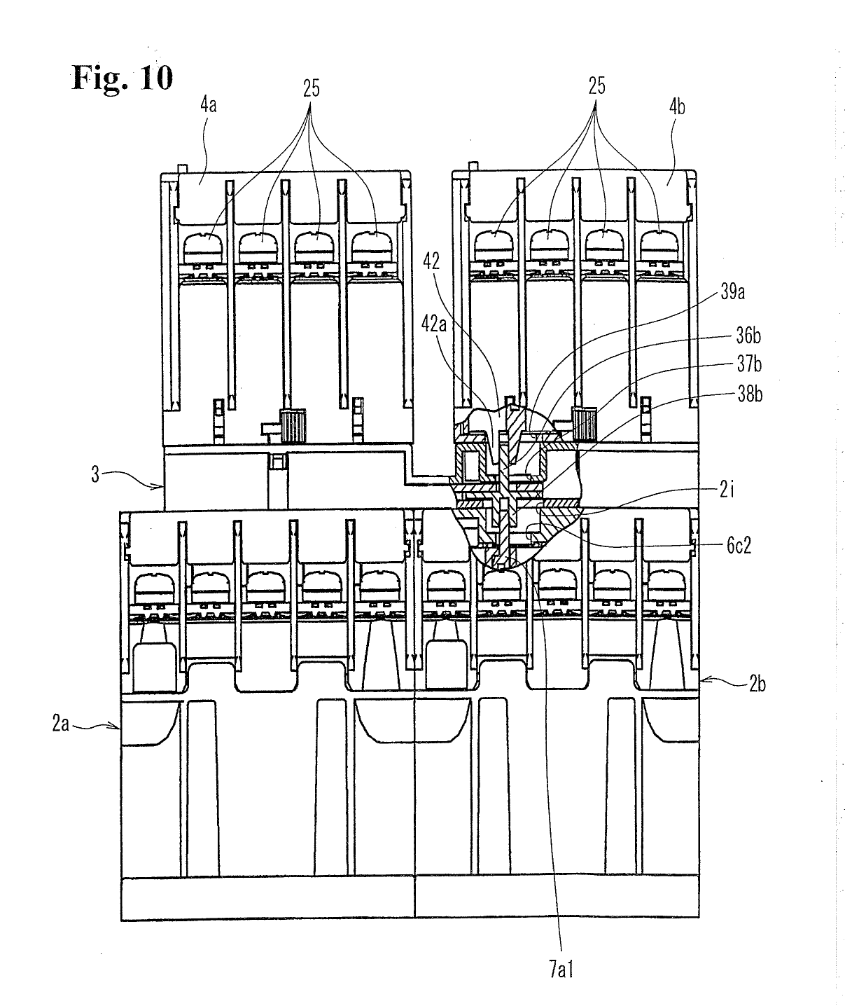

FIGS. 11(a) and 11(b) show the auxiliary contact unit, wherein FIG. 11(a) is a perspective view illustrating the auxiliary contact unit that can be mounted on the electromagnetic contactor; and FIG. 11(b) is a perspective view illustrating the auxiliary contact unit that cannot be mounted on the electromagnetic contactor.

FIGS. 12(a) to 12(c) illustrate the state in which the non-mountable auxiliary contact unit is mounted on the reversible unit.

### BEST MODE FOR CARRYING OUT THE INVENTION

An embodiment of the present invention will be described below with reference to the appended drawings.

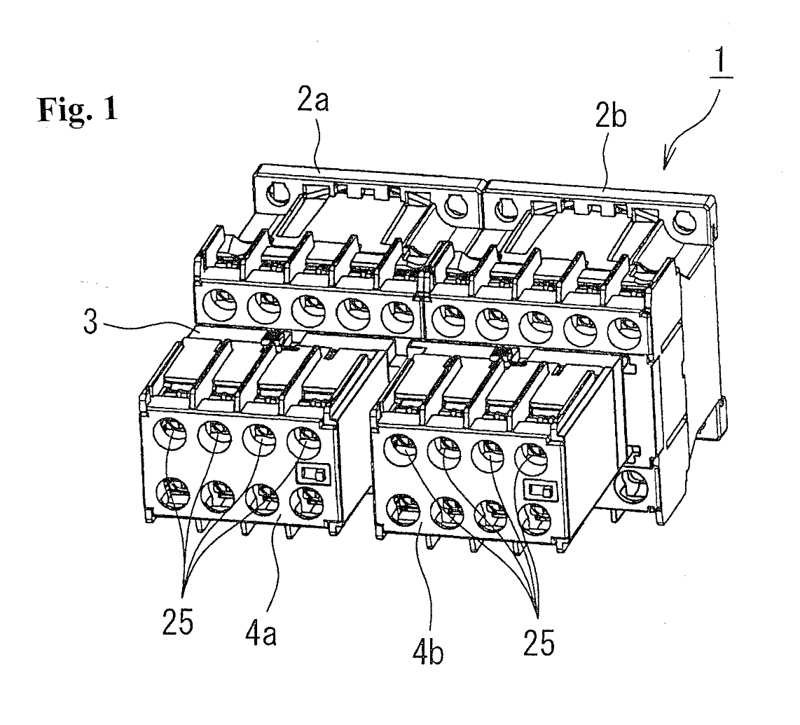

FIG. 1 is a perspective view illustrating an electromagnetic contactor device that is connected to a power feed circuit of a three-phase induction motor (not shown in the figure) and performs forward reverse control of the induction motor. An electromagnetic contactor device 1 is constituted by two electromagnetic contactors 2a, 2b, one reversible unit 3, two auxiliary contact units 4a, 4b serving as mountable units, and two auxiliary contact units 5a, 5b serving as non-mountable units.

Among the two electromagnetic contactors 2a, 2b, one electromagnetic contactor 2a is an electromagnetic contactor that performs forward control of the induction motor, and the other electromagnetic contactor 2b is an electromagnetic contactor that performs reverse control of the induction motor.

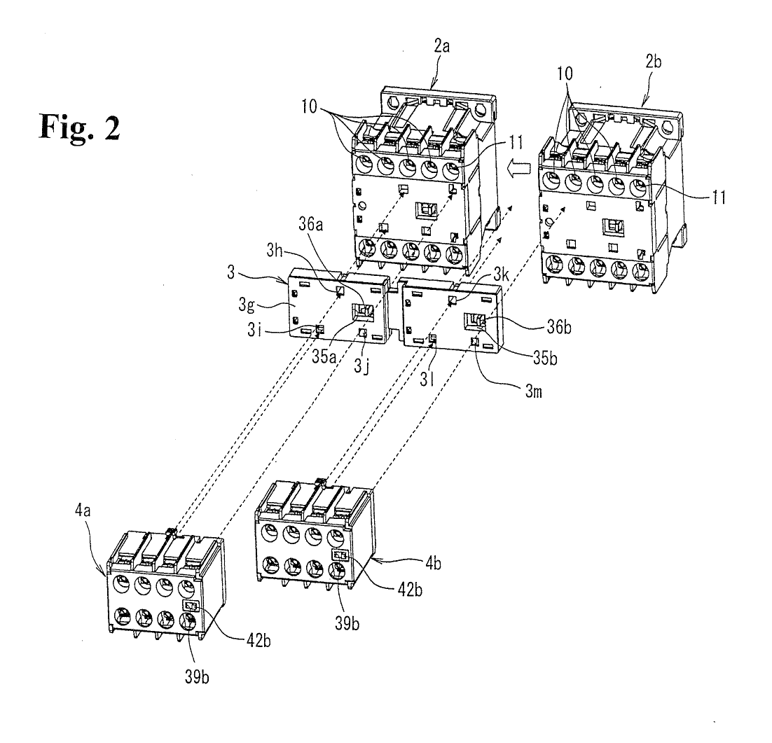

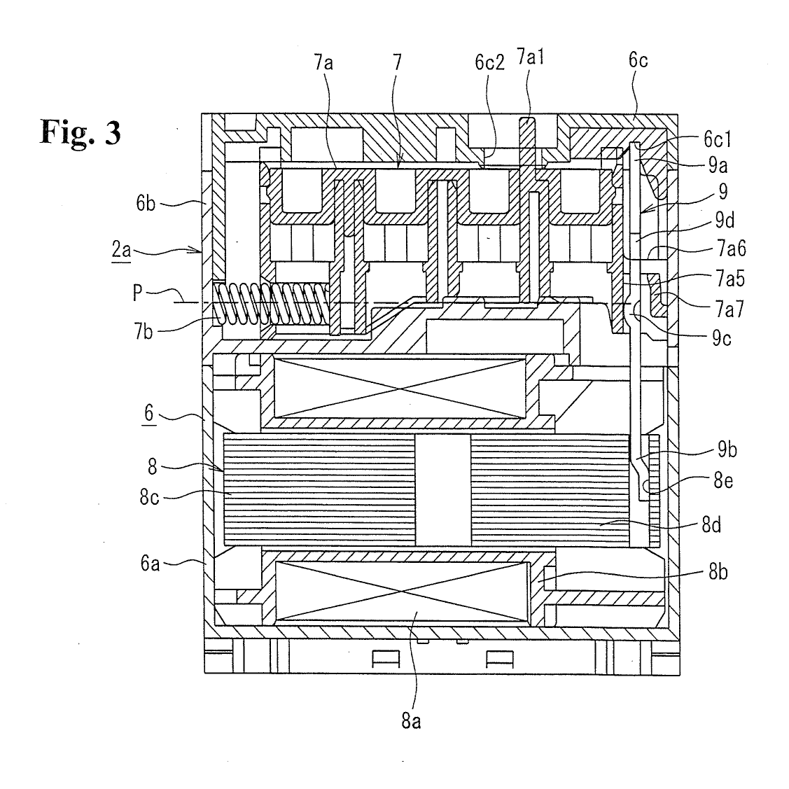

As shown in FIG. 2, the electromagnetic contactor 2a is a device provided with terminal portions 10 having respective contacts and a coil terminal portion 11 on the upper surface. As shown in FIG. 3, a contact portion 7, an electromagnet 8, and a drive lever 9 are accommodated in a main body case 6.

The main body case 6 has a lower case 6a accommodating the electromagnet 8, an upper case 6b accommodating the contact portion 7, and an arc-suppressing cover 6c that covers the upper portion of the upper case 6b.

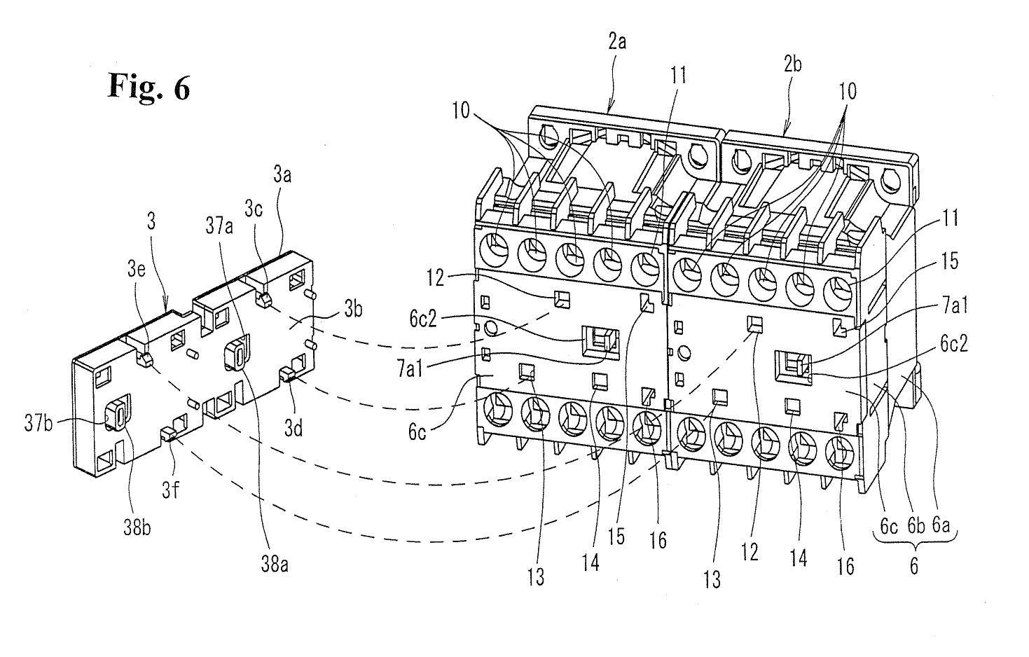

A rectangular display window 6c2 that passes through from the front surface to the rear surface is formed in the arc-suppressing cover 6c. An operation display piece 7a1 of the contact portion 7 protrudes through the display window 6c2 to the upper surface. Further, as shown in FIG. 6, connection holes 12 to 14 that enable connection of the one reversible unit 3 are formed in the arc-suppressing cover 6c to pass through from the front surface to the rear surface. The connection holes 12 to 14 have square openings.

As shown in FIG. 3, the contact portion 7 is constituted by a movable contact support 7a provided inside the upper case 6b so that the movable contact support can slide in the predetermined direction and a return spring 7b that pushes unidirectionally the movable contact support 7a.

The electromagnet 8 includes a coil frame 8b that has an excitation coil 8a mounted thereon and has an axial direction thereof set parallel to the sliding direction of the movable contact support 7a, a fixed core 8c inserted into the cavity of the coil frame 8b and fixed to the side wall of the lower case 6a, and a movable core 8d that is inserted into the cavity of the coil frame 8b and set opposite the fixed core 8c so as to be capable of being moved close thereto and withdrawn therefrom.

As shown in FIG. 3, the side of the movable contact support 7a that is opposite the side facing the return spring 7b is connected by the drive lever 9 to the movable core 8d of the electromagnet 8 in order to transmit the attraction movement and release movement of the movable core 8d to the movable contact support 7a.

The drive lever 9 is a plate-shaped member. The upper end thereof in the lengthwise direction serves as a rotation fulcrum portion 9a, a movable core connection portion 9b is formed at the other end in the lengthwise direction, a movable contact support connection portion 9c is provided in the central portion in the lengthwise direction, and a pair of supported portions 9d is formed at positions closer to the rotation fulcrum portion 9a than to the movable contact support connection portion 9c.

The movable core connection portion 9b of the drive lever 9 is inserted from above into a connection orifice 8e formed in the movable core 8d and connected thereto.

Further, as shown in FIG. 3, in order to transmit the attraction movement and release movement of the movable core 8d to the movable contact support 7a, the drive lever 9 connected to the movable core 8d and one end side of the movable contact support 7a withdrawn from the return spring 7b is accommodated in the extending condition between the lower case 6a and the upper case 6b.

The rotation fulcrum portion 9a of the drive lever 9 is fit into a fulcrum depression 6c1 provided in the lower surface of the arc-suppressing cover 6c and rotatably connected thereto.

The other one of electromagnetic contactors 2b has a structure identical to that of the one of electromagnetic contactors 2a and detailed explanation thereof is herein omitted.

The reversible unit 3 is an interlock device in which the two electromagnetic contactors 2a, 2b are disposed adjacently and fixed to one another and which mechanically locks the simultaneous closed-circuit (ON) state of the two electromagnetic contactors 2a, 2b even when operation signals are inputted by some operation into both electromagnetic contactors 2a, 2b (electromagnets 8 of the two electromagnetic contactors 2a, 2b are simultaneously actuated).

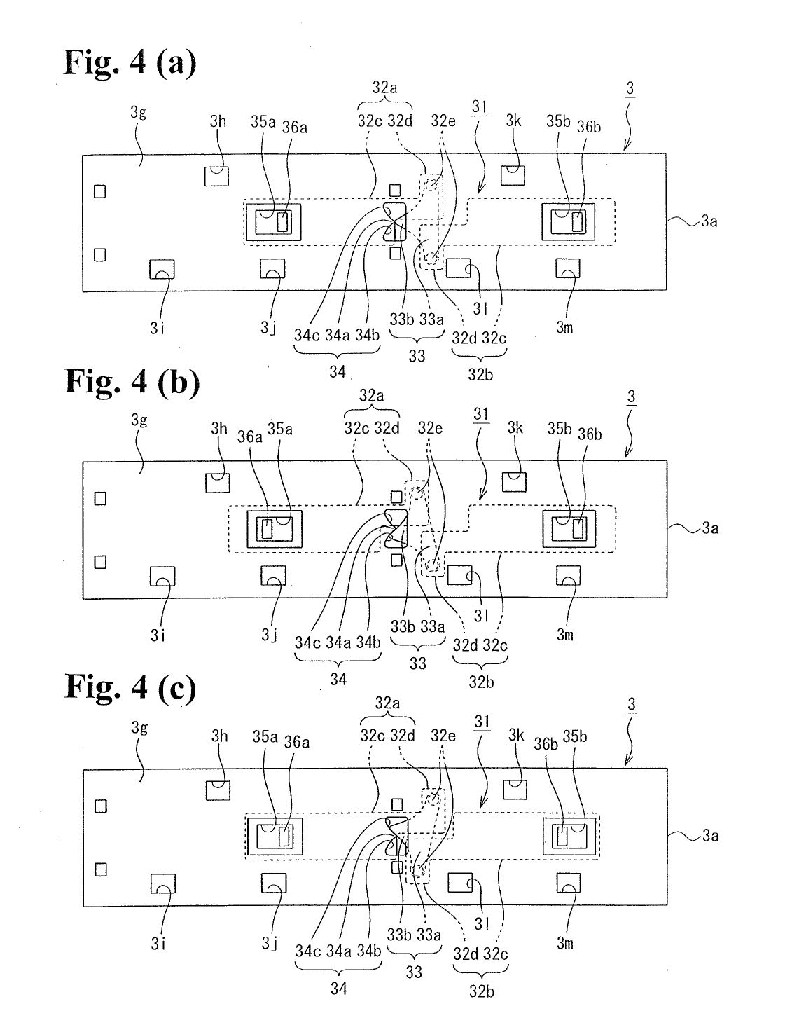

As shown in FIGS. 4(a)-4(c) and 6, the reversible unit 3 has a unit main body 3a in the form of a rectangular parallelepiped and snap pieces 3c to 3f having hook portions with outwardly protruding distal ends that protrude from the contactor mounting portion 3b on the rear surface side of the unit main body 3a abutting on the arc-suppressing covers 6c of the two adjacently disposed electromagnetic contactors 2a, 2b.

Further, in the reversible unit 3, connection holes 3h, 3i, 3j, 3k, 3l, 3m that engage with a snap piece 40a and hook pieces 40b, 40c of the below-described auxiliary contact units 4a, 4b or 5a, 5b are formed in the unit mounting portion 3g for mounting the auxiliary contact units 4a, 4b or 5a, 5b on the front surface side of the unit main body 3a.

An interlock mechanism 31 that mechanically locks the simultaneous closed-circuit (ON) state of the two electromagnetic contactors 2a, 2b is provided inside the unit main body 3a. As shown in FIG. 4, the interlock mechanism 31 is constituted by sliding members 32a, 32b that are individually connected to the operation display piece 7a1 of the electromagnetic contactors 2a, 2b and can slide in the coupling direction, that is, lengthwise direction, of the electromagnetic contactors 2a, 2b, a sliding restricting member 33 that connects the opposing portions of the these sliding members 32a, 32b at one surface side, from among the front and rear surface sides, and restricts the sliding of one of the sliding members 32a, 32b relative to the sliding of the other, and a rotation restricting member 34 that faces the sliding restricting member 33 and restricts the rotation thereof.

The sliding members 32a, 32b are formed to have the same, point symmetrical shape, in the plan view thereof, and constituted by a rectangular plate portion 32c and a hook-like portion 32d formed on the outside at the inner end of the rectangular plate portion 32c and bent outward in the direction perpendicular to the lengthwise direction. The sliding members 32a and 32b are disposed so that the hook-like portions 32d are opposite each other in a back-to-back state, as shown in FIG. 4(a), in the released state (lock release state).

The sliding restricting member 33 is constituted by a base portion 33a engaged with an engagement pin 32e formed at the outward end side of the hook-like portion 32d of the sliding members 32a and 32b and a triangular protruding portion 33b protruding from the center of the base portion 33a toward the sliding member 32a side.

The rotation restricting member 34 has at least an apex portion 34a that adjacently faces the apex portion of the triangular protruding portion 33b of the sliding restricting member 33 in the released state, a rotation restricting wall portion 34b that is circular-arc surface following the movement trajectory of the apex portion of the triangular protruding portion 33b generated when the sliding member 32a is caused to slide from the released state through the apex portion 34a, and a rotation restricting wall portion 34c that is circular-arc surface following the movement trajectory of the apex portion of the triangular protruding portion 33b generated when the sliding member 32b is caused to slide from the released state through the apex portion 34b.

In the sliding members 32a and 32b, operation display pieces 36a and 36b that protrude from rectangular unit windows 35a and 35b formed in the surface of the unit main body 3a are formed at the front surface side, as shown in FIG. 4, and tubular display piece engagement portions 38a and 38b that protrude from the rectangular unit windows 37a and 37b formed in the rear surface of the unit main body 3a are formed at the rear surface side, as shown in FIG. 6.

With the aforementioned electromagnetic contactors 2a, 2b being in the open-circuit (OFF) state, the reversible unit 3 is mounted on the electromagnetic contactors 2a and 2b. In this case, as shown in FIG. 6, the distal end of the snap piece 3c of the reversible unit 3 is inserted into the connection hole 12 of the electromagnetic contactor 2a and engaged with the circumferential edge of the opening, and the distal end of the snap piece 3d is inserted into the connection hole 13 of the electromagnetic contactor 2a and engaged with the circumferential edge of the opening, while the display piece engagement portions 38a and 38b of the reversible unit 3 are being engaged with the respective operation display pieces 7a1 of the electromagnetic contactors 2a, 2b. Then, the distal end of the snap piece 3e of the reversible unit 3 is inserted into the connection hole 12 of the electromagnetic contactor 2b and engaged with the circumferential edge of the opening, and the distal end of the snap piece 3f is inserted into the connection hole 13 of the electromagnetic contactor 2b and engaged with the circumferential edge of the opening. As a result, the reversible unit 3 is mounted on the electromagnetic contactors 2a and 2b.

In the mounted state of the reversible unit 3, the electromagnetic contactors 2a and 2b are both in the open-circuit (OFF) state. Therefore, as shown in FIG. 4(a), in the interlock mechanism 31, the sliding members 32a and 32b are both at the right positions and assume the released state, and the base portion 33a of the sliding restricting member 33 is oriented substantially perpendicular to the lengthwise direction. Therefore, the apex portion of the triangular protruding portion 33b in the sliding restricting member 33 of the interlock mechanism 31 adjacently faces the apex portion 34a of the rotation restricting member 34, and the sliding restricting member 33 can rotate about one end of the base portion 33a as a center.

Where the electromagnetic contactor 2a is set to the closed-circuit (ON) state from the released state of the interlock mechanism 31, the movable core 8d of the electromagnetic contactor 2a is attracted and moved to the fixed core 8c. Following this movement, the movable contact support 7a of the contact portion 7 moves via the drive lever 9 against the force of the return spring 7b and assumes the inserted state.

Where the electromagnetic contactor 2a thus assumes the inserted state, the operation display piece 7a1 of the contact portion 7 of the electromagnetic contactor 2a moves from the open-circuit (OFF) position shown in FIG. 4(a) to the closed-circuit position shown in FIG. 4(b). Since the sliding member 32a of the reversible unit 3 is connected to the operation display piece 7a1, the sliding member 32a moves from the open-circuit (ON) position shown in FIG. 4(a) to the closed-circuit position and assumes a left-side inserted state as shown in FIG. 4(b). Therefore, the sliding restricting member 33 rotates counterclockwise about the engagement pin 32e of the sliding member 32b as a center, and the triangular protruding portion 33b contacts with or adjacently faces the rotation restricting wall portion 34b of the rotation restricting member 34.

In the left-side inserted state, the triangular protruding portion 33b of the sliding restricting member 33 contacts with or adjacently faces the rotation restricting wall portion 34b of the rotation restricting member 34. Therefore, when the right electromagnetic contactor 2b is to be set in the closed-circuit (OFF) state, the sliding member 32b of the interlock mechanism 31 is to be moved via the display piece 7a1 of the electromagnetic contactor 2b from the open-circuit (OFF) position shown in FIG. 4(b) to the closed-circuit (ON) position on the sliding member 32b side. As a result, the sliding restricting member 33 will be rotated clockwise about the engagement pin 32e of the sliding restricting member 32a as a center, but because the triangular protruding portion 33b contacts with the rotation restricting wall portion 34b of the rotation restricting member 34, the sliding restricting member 33 is prevented from rotating. As a result, when the left electromagnetic contactor 2a is in the closed-circuit (ON) state, the right electromagnetic contactor 2b is reliably prevented from switching to the closed-circuit (ON) state.

Likewise, where the right electromagnetic contactor 2b is set to the closed-circuit (ON) state, as shown in FIG. 4(c), when the interlock mechanism 31 of the reversible unit 3 is in the released state, as shown in FIG. 4(a), the sliding member 32b of the interlock mechanism 31 moves to the sliding member 32a side via the operation display piece 7a1 of the electromagnetic contactor 2b. Following this movement, the sliding restricting member 33 rotates clockwise about the engagement pin 32e of the sliding member 32a as a center and the triangular protruding portion 33a contacts with or adjacently faces the rotation restricting wall portion 34c of the rotation restricting member 34. Therefore, by restricting the counterclockwise rotation of the sliding restricting member 33, it is possible to prevent the sliding member 32a from sliding in the direction of withdrawal from the sliding member 32b. Therefore, the left electromagnetic contactor 2a is reliably prevented from switching from the open-circuit (OFF) state to the closed-circuit (ON) state.

The auxiliary contact units 4a, 4b as mountable units and the auxiliary contact units 5a, 5b as non-mountable units are all the devices having auxiliary circuit terminals 25, as shown in FIG. 1.

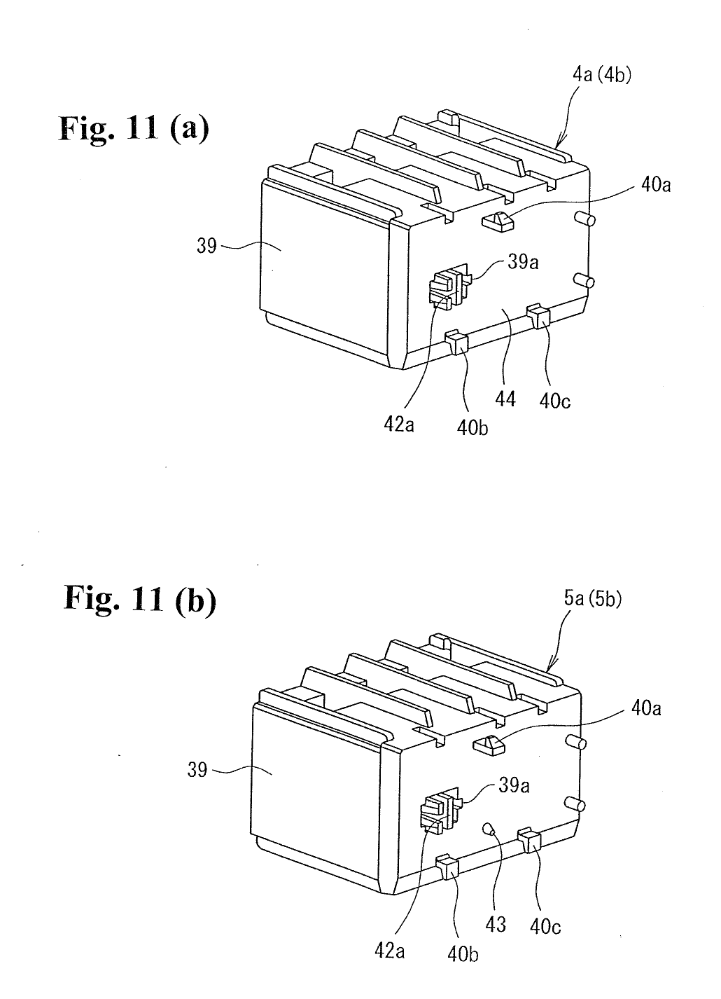

As shown in FIG. 11(a), the auxiliary contact unit 4a has a contact portion (not shown in the figure) inside the main body case 39 and is also provided with the snap piece 40a that protrudes downward from one side of the bottom surface of the main body case 39 and has a locking hook that protrudes outward and locks with the connection hole 12 of the electromagnetic contactors 2a, 2b and the connection hole 3h or connection hole 3k of the reversible unit 3 and hook pieces 40b, 40c with an inversed L-shaped cross section that protrude in the same direction from the other side of the bottom surface of the main body case 39 and have outward protruding lower ends that are locked to the connection holes 13, 14 of the electromagnetic contactors 2a, 2b and also connection holes 3i, 3j or connection holes 3l, 3m of the reversible unit 3.

Further, a display piece engagement portion 42a that can engage and move integrally with the operation display pieces 7a1 of the electromagnetic contactors 2a and 2b or the reversible unit operation display pieces 36a, 36b of the reversible unit 3 is formed at the lower surface of the main body case 39 so as to protrude from the unit window 39a formed in the lower surface of the main body case 39. The display piece engagement portion 42a is connected to the movable contact support (not shown in the figure) similar to the movable contact support 7a in the contact portion 7 of the above-described electromagnetic contactors 2a, 2b and provided inside the main body case 39. The display piece engagement portion 42a is also connected to an auxiliary contact unit operation display piece 42b protruding from the unit window 39b formed in the upper surface of the main body case 39.

Inside the main body case 39, there are also provided a return spring (not shown in the figure) creating a spring urging force that urges the movable contact support to one side similarly to the contact portion 7 of the above-described electromagnetic contactors 2a, 2b, a plurality of movable contacts (not shown in the figure), each supported by a contact spring (creating a spring bias force in the direction opposite that of the spring bias force created by the return spring) to enable movement in the same direction as the movable contact support, and a plurality of fixed contacts (not shown in the figure) supported on the main body case 39 so as to face the plurality of movable contacts in the movement direction.

As shown in Table 1 below, the auxiliary contact units include auxiliary contact units 4a, 4b serving as mountable units that can be mounted on the electromagnetic contactors 2a, 2b and auxiliary contact units 5a, 5b as non-mountable units. Thus, when the electromagnetic contactors 2a, 2b have contact configurations of two systems, namely, A and B, and the auxiliary contact units are also of two systems, namely, of a two-contact type [I] and a four-contact type [II], the auxiliary contact units 4a, 4b of the two-contact type [I] can be mounted on both the A-type electromagnetic contactor and the B-type electromagnetic contactor, whereas the auxiliary contact units 5a, 5b of the four-contact type [II] can be mounted on the A-type electromagnetic contactor, but cannot be mounted on the B-type electromagnetic contactor.

TABLE 1

Auxiliary contact unit

| | | [I] | [II] |
|---|---|---|---|
| Electromagnetic | [A] | ◯ | ◯ |
| contactor | [B] | ◯ | X |

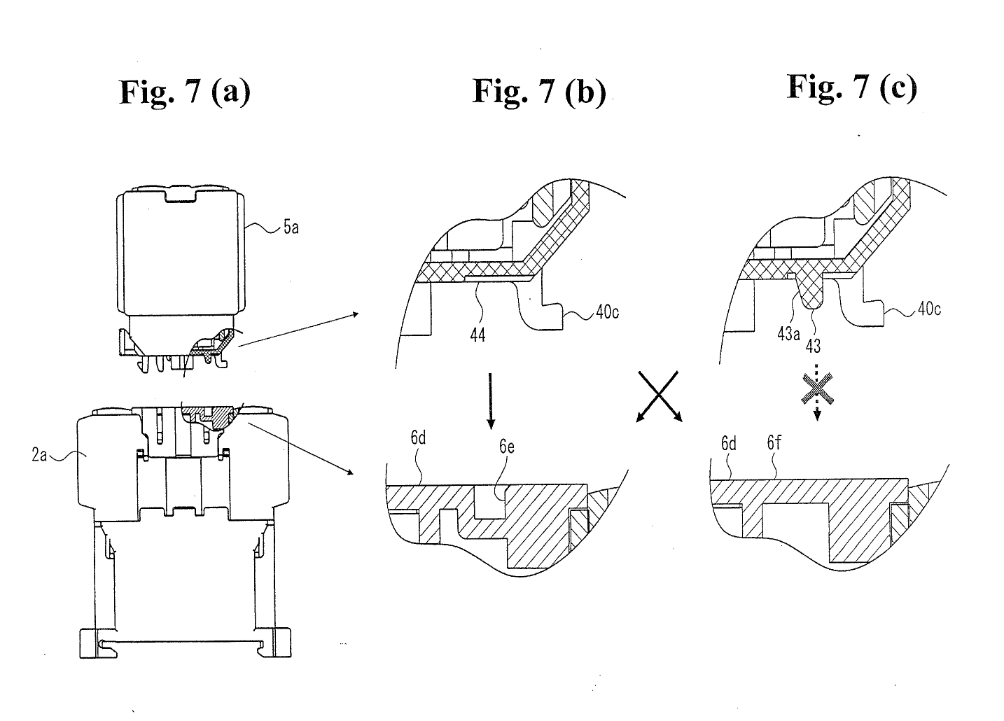

Therefore, in order to prevent erroneous mounting of the auxiliary contact units 5a, 5b that cannot be mounted on the electromagnetic contactor, a unit-side mounting preventing portion 43 is provided on the lower surface side of the main body case 19 of the auxiliary contact units 5a, 5b of the four-contact type [II] for which mountable electromagnetic contactors and non-mountable electromagnetic contactors are present. The unit-side mounting preventing portion 43 is an engaging protrusion that protrudes downward at a position between the hook portions 40b and 40c and at a position that is close to the line connecting the hook portions 40b and 40c on the inner side thereof, as shown in FIG. 7(c) and FIG. 11(b). The unit-side mounting preventing portion 43 has a tilted surface 43a on the side opposite that facing the hook portions 40b and 40c, this tilted surface being tapered from the bottom surface of the main body case 39 toward the distal end.

By contrast, in the auxiliary contact unit of the two-contact type [I], which can be mounted regardless of the electromagnetic contactor type, the flat surface 44 is provided that has no unit-side mounting preventing portion 43 formed thereon, as shown in FIG. 7(b) and FIG. 11(a).

In the A-type electromagnetic contactors 2a, 2b on which all of the auxiliary contact units can be mounted, as shown in FIG. 7(b), a contactor-side mounting allowing portion 6e that is an engagement depression for engagement with the unit-side mounting preventing portion 43 is formed at a position opposite the unit-side mounting preventing portion 43 in the unit attaching portion 6d on the upper surface of the arc-suppressing cover 6c.

By contrast, in the B-type electromagnetic contactors 2a, 2b on which the auxiliary contact units 5a, 5b of the four-contact type [II] cannot be mounted, as shown in FIG. 7(c), a contactor-side mounting preventing portion 6f, which is a flat surface preventing the erroneous mounting, is formed at a position opposite the unit-side mounting preventing portion 43a in the unit attaching portion 6d of the upper surface of the arc-suppressing cover 6c.

Thus, in order to prevent erroneous mounting, the electromagnetic contactors 2a, 2b and the auxiliary contact units 5a, 5b are provided with the contactor-side mounting allowing portion 6e, contactor-side mounting preventing portion 6f, and unit-side mounting preventing portion 43, and these portions constitute an erroneous mounting preventing mechanism. In the auxiliary contact units 4a, 4b, the unit-side mounting preventing portion 43 is omitted and the flat surface 44 is formed.

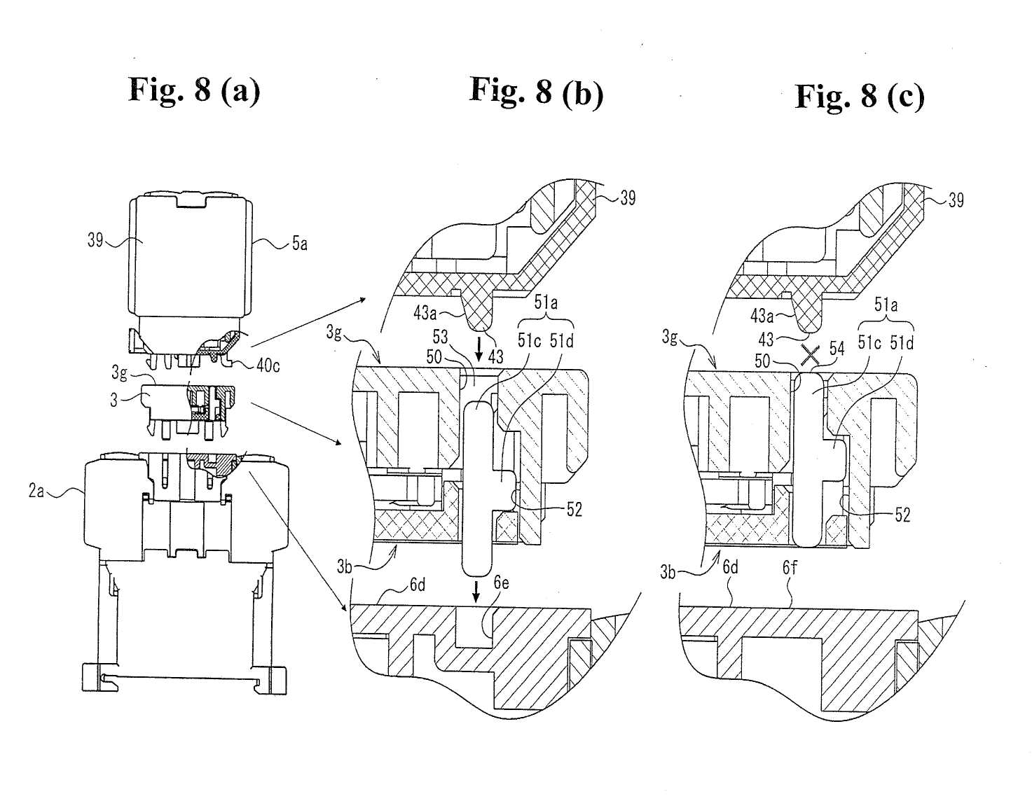

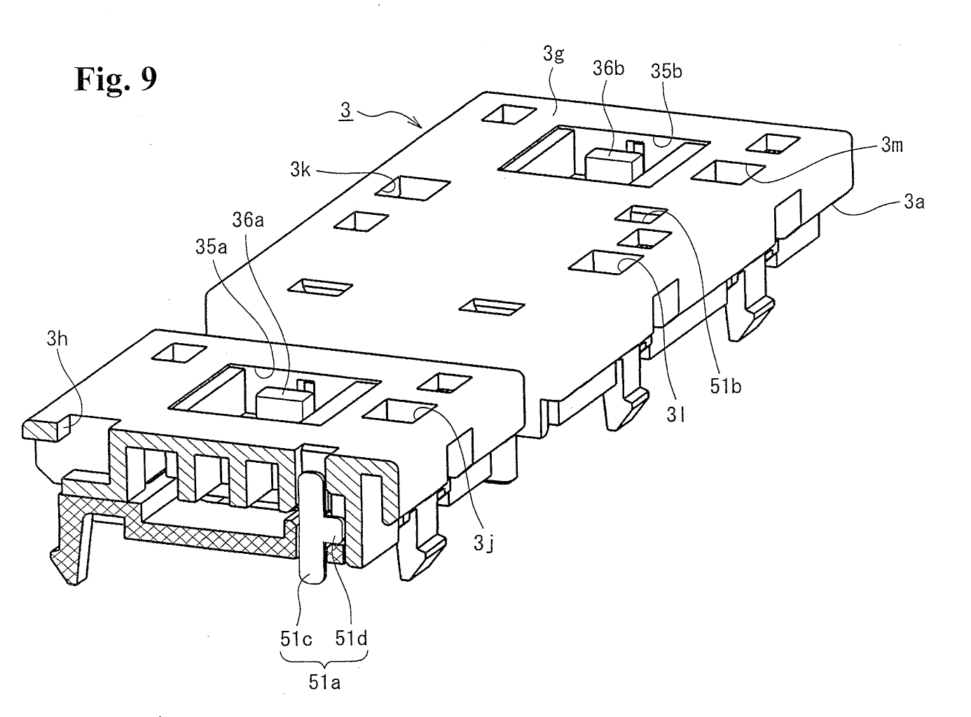

By contrast, in the reversible unit 3, as shown in FIGS. 8(a)-8(c) and FIG. 9, through holes 50a, 50b with a square cross section that pass from the front surface to the rear surface are formed at positions opposite the engagement depression 6e formed in the arc-suppressing cover 6c of the electromagnetic contactors 2a, 2b. In a state in which the reversible unit 3 is mounted on the electromagnetic contactors 2a, 2b, mounting preventing transfer members 51a, 51b that transfer the contactor-side mounting allowing portion 6e or the contactor-side mounting preventing portion 6f, which is formed in the arc-suppressing cover 6c of the electromagnetic contactors 2a, 2b, to the unit mounting portion 23g on the upper surface side are slidably inserted into the aforementioned through holes 50a, 50b. Each of these mounting preventing transfer members 51a, 51b is constituted by a rod-shaped portion 51c, for example formed in a quadrangular columnar shape, that is inserted in the through holes 50a, 50b and a fall-out preventing portion 51d that is formed to protrude outward in the intermediate portion of the rod-shaped portion 51c. The fall-out preventing portion 51d communicates with the through holes 50a, 50b inside the case main body 3a and is engaged with a guiding groove 52 that is closed at the front and rear surface sides. The length of the rod-shaped portion 51c is set to be substantially equal to the distance between the front and rear surfaces of the reversible unit 3.

The operation of the above-described embodiment will be described below.

In order to mount a pair of electromagnetic contactors 2a, 2b on the reversible unit 3, first, the electromagnetic contactors 2a, 2b contact with one another by the side walls thereof in a state in which the two electromagnetic contactors are oriented in the same direction. In this state, the electromagnets 8 of the electromagnetic contactors 2a, 2b are in a non-conductive state, and the movable contact support 7a of the contact portion 7 is pushed by the return spring 7b and maintained in the open-circuit (OFF) state. Therefore, the operation display piece 7a1 of the electromagnetic contactors 2a, 2b is in the open-circuit position on the right side, as shown in FIG. 6.

In this state in which the reversible unit 3 is set such that the operation display pieces 36a and 36b are at the open-circuit position at the right side, the snap pieces 3c, 3d and 3e, 3f of the reversible unit 3 are located opposite the connection holes 12, 13 formed in the arc-suppressing cover 6c of the electromagnetic contactor 2a and the connection holes 12, 13 formed in the arc-suppressing cover 6c of the electromagnetic contactor 2b, respectively. Where the reversible unit 3 is pushed down toward the electromagnetic contactors 2a, 2b side in this state, the snap pieces 3c, 3d and 3e, 3f are inserted and locked in the connection holes 12, 13 of the electromagnetic contactors 2a, 2b, and the display piece engagement portions 38a and 38b of the reversible unit 3 are engaged with the operation display pieces 7a1 of the electromagnetic contactors 2a and 2b.

In the case in which the electromagnetic contactors 2a and 2b are of the A type that enables mounting, regardless of the type of the auxiliary contact units 4a, 4b, the contactor-side mounting allowing portion 6e, which is constituted by an engagement depression, is formed at the intermediate position, in the longitudinal direction, of the two connection holes 13, 14 close to and on the inner side of the line connecting the connection holes 13, 14 in the arc-suppressing cover 6c of the electromagnetic contactors.

Therefore, when the reversible unit 3 is mounted on the electromagnetic contactors 2a, 2b, as shown in FIG. 8(b), the mounting preventing transfer members 51a and 51b of the reversible unit 3 face the contactor-side mounting allowing portions 6e of the electromagnetic contactors 2a and 2b, respectively, and these mounting preventing transfer members 51a and 51b are engaged or can be engaged with the contactor-side mounting allowing portions 6e.

Where mounting of the reversible unit 3 on the electromagnetic contactors 2a, 2b is thus completed, the auxiliary contact units 4a, 4b or 5a, 5b are mounted on the unit mounting portion 3g of the reversible unit 3.

In this case, as shown in FIG. 7(b), the unit-side mounting preventing portion 43 is not formed at the position opposite the contactor-side mounting preventing portion 6e of the electromagnetic contactors 2a, 2b on the lower surface of the auxiliary contact units 4a, 4b that can be mounted on both A type and B type of the electromagnetic contactors 2a, 2b, and this lower surface is the flat surface 44.

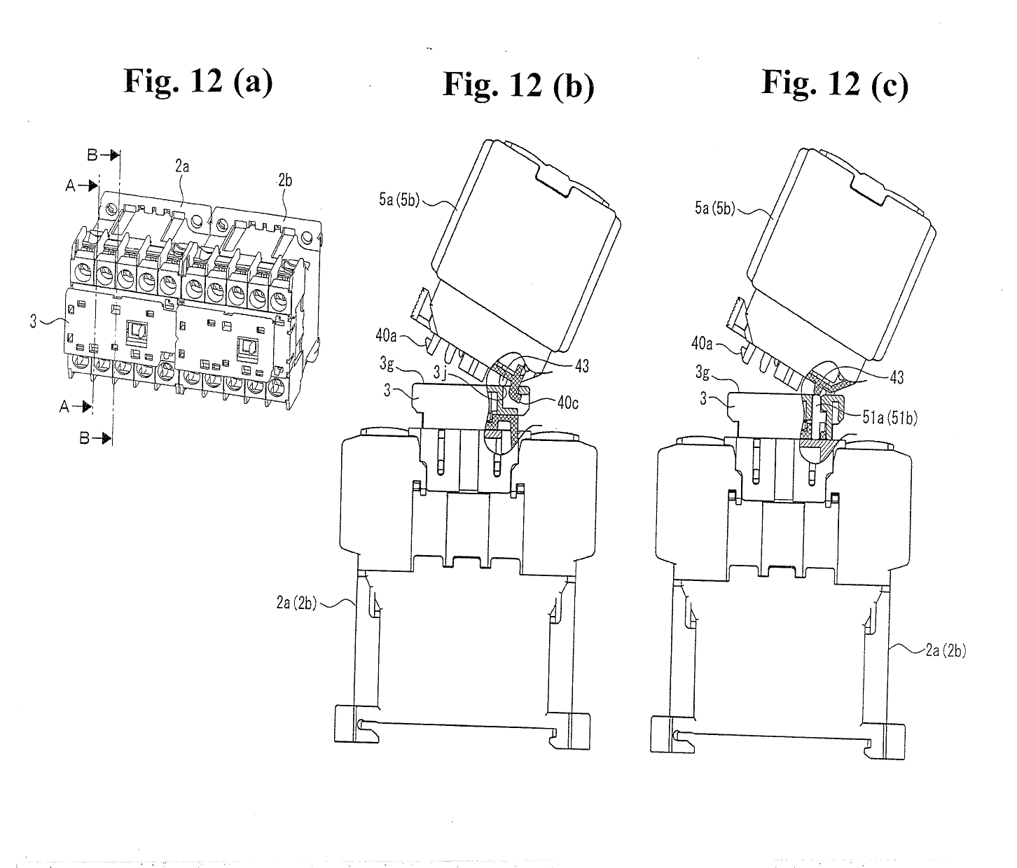

Therefore, for example, in order to mount the auxiliary contact unit 4a on the reversible unit 3, the auxiliary contact unit 4a is tilted as shown in FIG. 12(b), and the hook pieces 40b, 40c formed at the rear surface side are inserted and locked in the connection holes 3i, 3j formed in the unit mounting portion 3g of the reversible unit 3. Then, the lower surface of the auxiliary contact unit 4a is rotated to contact with the unit mounting portion 3g of the reversible unit 3, and the snap piece 40a is inserted and locked in the connection hole 3h formed in the unit mounting portion 3g of the reversible unit 3. In this case, since the unit-side mounting preventing portion 43 is not formed at the rear surface of the auxiliary contact unit 4a and this rear surface is the flat surface 44, the rear surface of the auxiliary contact unit 4a intimately contacts with and mounted on the unit mounting portion 3g of the reversible unit 3.

The auxiliary contact unit 4b can be also mounted on the reversible unit 3 in a similar manner.

By contrast, in the auxiliary contact units 5a, 5b where the non-mountable electromagnetic contactors 2a, 2b are present, the unit-side mounting preventing portion 43 constituted by an engagement protrusion is formed, as shown in FIGS. 8(a)-8(c) and FIGS. 11(a)-11(b), close to and on the inner side of a line connecting the hook portions 40b, 40c and at a position between the hook pieces 40b, 40c. Therefore, when the auxiliary contact units 5a, 5b are attempted to be mounted on the unit mounting portion 3g of the reversible unit 3 in the same manner as described above, the unit mounting preventing portion 43 engages with the mounting preventing transfer members 51a, 51b. In this case, the contactor side mounting allowing portion 6e is formed at the electromagnetic contactors 2a, 2b and the mounting preventing transfer members 51a, 51b are opposite the contactor-side mounting allowing portion 6e.

When the mounting preventing transfer members 51a, 51b engage inside the contactor-side mounting allowing portion 6e, as shown in FIG. 8(b), the unit-side mounting allowing portion 53 similar to the contactor-side mounting allowing portion 6e of the electromagnetic contactors 2a, 2b is formed on the upper end side of the mounting preventing transfer members 51a, 51b. The unit-side mounting preventing portion 43 can engage with the unit-side mounting allowing portion 53, and the auxiliary contact units 5a, 5b can be brought into intimate contact with and mounted on the unit mounting portion 3g of the reversible unit 3.

Further, when the mounting preventing transfer members 51a, 51b are not engaged inside the contactor-side mounting allowing portion 6e, the unit-side mounting allowing portion 53 is not formed at the unit mounting portion 3g of the reversible unit 3. However, when the auxiliary contact unit 4a (or 4b) is tilted, the hook pieces 40b, 40c are locked in the connection holes 3i, 3j (or 3l, 3m) of the reversible unit 3 and then the lower surface is rotated so as to contact with the unit mounting portion 3g, the upper end of the mounting preventing transfer members 51a, 51b is pushed by the unit mounting preventing portion 43 and the lower ends of the mounting preventing transfer members 51a, 51b are engaged inside the contactor-side mounting allowing portion 6e. For this reason, the mounting preventing transfer members 51a, 51b move down and the unit-side mounting allowing portion 53 similar to the contactor-side mounting allowing portion 6e of the electromagnetic contactors 2a, 2b is formed. Therefore, the snap piece 40a of the auxiliary contact units 4a, 4b can be inserted into the connection hole 3h of the unit mounting portion 3g of the reversible unit 3, and the lower surface of the auxiliary contact units 4a, 4b can be in intimate contact with and mounted on the unit mounting portion 3g of the reversible unit 3.

However, in the electromagnetic contactors 2a, 2b of the B type on which the auxiliary contact units 5a, 5b cannot be mounted, the contactor-side mounting allowing portion 6e is not formed at the position opposite the unit-side mounting preventing portion 43 of the auxiliary contact units 5a, 5b of the arc-suppressing cover 6c and the flat contactor-side mounting preventing portion 6f is formed, as shown in FIG. 7(c).

Therefore, when the reversible unit 3 is mounted on the electromagnetic contactors 2a, 2b as described hereinabove, since the contactor-side mounting allowing portion 6e is not present, as shown in FIG. 8(c), the mounting preventing transfer members 51a, 51b cannot protrude downward from the contactor mounting portion 3b of the reversible unit 3. Therefore, the upper surface of the mounting preventing transfer members 51a, 51b is flush with the front surface of the unit mounting portion 3g of the reversible unit 3 and the unit-side mounting preventing portion 54 is formed. This unit-side mounting preventing portion 54 is a flat surface similar to the contactor-side mounting preventing portion 6f of the electromagnetic contactors 2a, 2b where the contactor-side mounting allowing portion 6e is not formed.

Therefore, when the auxiliary contact units 4a, 4b, which are mountable units that can be mounted on the electromagnetic contactors 2a, 2b, are mounted on the unit mounting portion 3g of the reversible unit 3, the unit-side mounting preventing portion 43 is not formed at these auxiliary contact units 4a, 4b, as shown in FIG. 7(b) and the flat surface 44 is formed instead thereof. Therefore, although the upper surface of the mounting preventing transfer members 51a, 51b of the reversible unit 3 is flush with the front surface of the unit mounting portion 3g, mounting can be normally performed.

However, when the auxiliary contact units 5a, 5b, which are non-mountable units that cannot be mounted on the electromagnetic contactors 2a, 2b, are mounted on the unit mounting portion 3g of the reversible unit 3, the unit-side mounting preventing portion 43 is formed, as shown in FIGS. 8, 11, and 12, at the lower surface of these auxiliary contact units 5a, 5b. Therefore, where the auxiliary contact unit 5a (or 5b) is rotated counterclockwise, while being tilted, as shown in FIG. 12(a), so that the rear surface of the auxiliary contact unit 5a (or 5b) is mated with the unit mounting portion 3g of the reversible unit 3 in a state in which the hook pieces 40c, 40d are engaged with the connection holes 3i, 3j (or 3l, 3m) formed in the unit mounting portion 3g of the reversible unit 3, the distal end of the unit-side mounting preventing portion 43 abuts on the distal end of the mounting preventing transfer member 51a (or 51b) as shown in FIG. 12(b). Counterclockwise rotation of the auxiliary contact unit 5a (or 5b) is thereby prevented. As a result, the auxiliary contact unit 5a (or 5b) remains in the tilted state, the snap piece 40a cannot be locked to the connection hole 3h (or 3k) formed in the unit mounting portion 3g of the reversible unit 3, and the operator can clearly grasp the erroneous mounting state.

In this case, since the unit-side mounting preventing portion 43 is provided at a position close to the hook pieces 40b, 40c, even when the height of the engagement protrusion 43 is small, the auxiliary contact unit 5a (or 5b) can be prevented from mounting on the reversible unit 3 in a state in which the auxiliary contact unit 5a (or 5b) is significantly tilted.

Thus, according to the above-described embodiments, when the auxiliary contact units 5a, 5b that cannot be mounted on the electromagnetic contactors 2a, 2b are present, the unit-side mounting preventing portion 43 is formed on the mounting surface of the auxiliary contact units 5a, 5b. Furthermore, the contactor-side mounting allowing portion 6e that engages with the unit-side mounting preventing portion 43 is formed at the arc-suppressing cover 6c of the electromagnetic contactors 2a, 2b onto which the auxiliary contact units 5a, 5b can be mounted. Meanwhile, in the electromagnetic contactors 2a, 2b onto which the auxiliary contact units 5a, 5b cannot be mounted, the flat contactor-side mounting preventing portion 6f is formed at the arc-suppressing cover 6c at the position corresponding to the unit-side mounting allowing portion 6e. With such a configuration, erroneous mounting of the auxiliary contact units 5a, 5b can be reliably prevented.

Further, when the reversible unit 3 is mounted on the electromagnetic contactors 2a, 2b, the mounting preventing transfer members 51a, 51b are slidably provided at positions opposite the contactor-side mounting allowing portion 6e or contactor-side mounting preventing portion 6f of the reversible unit 3. Therefore, when the lower ends of the mounting preventing transfer members 51a, 51b are engaged with the contactor-side mounting allowing portion 6e, the unit-side mounting allowing portion 53 corresponding to the contactor-side mounting allowing portion 6e is formed at the unit mounting portion 3g of the reversible unit 3. By contrast, where the lower ends of the mounting preventing transfer members 51a, 51b abut on the contactor-side mounting preventing portion 6f, the upper ends of the mounting preventing transfer members 51a, 51b are flush with the flat surface of the unit mounting portion 3g of the reversible unit 3 and the flat unit-side mounting preventing portion 54 corresponding to the contactor-side mounting preventing portion 6f is formed.

As a result, the contactor-side mounting allowing portion 6e or the contactor-side mounting preventing portion 6f of the electromagnetic contactors 2a, 2b can be accurately transferred to the unit mounting portion 3g of the reversible unit 3 by the mounting preventing transfer members 51a, 51b, and even when the contactor-side mounting allowing portion 6e or the contactor-side mounting preventing portion 6f of the electromagnetic contactors 2a, 2b is covered by the reversible unit 3, erroneous mounting of the non-mountable auxiliary contact units 5a, 5b can be reliably prevented. Furthermore, a simple feature of providing the mounting preventing transfer members 51a, 51b slidably on the reversible unit 3 can be used for preventing such erroneous mounting.

Further, the unit-side mounting preventing portion 43 formed at the auxiliary contact units 5a, 5b that are non-mountable units which cannot be mounted on the electromagnetic contactors 2a, 2b is formed at the tilted surface 43a such that the side thereof opposite the side facing the hook pieces 40b and 40c is tapered gradually toward the distal end. The resultant merit is that when the auxiliary contact units 5a, 5b are mounted on the electromagnetic contactors 2a, 2b or the reversible unit 3 onto which the auxiliary contact units can be mounted, the engagement can be easily and reliably performed with the contactor-side mounting allowing portion 6e or the unit-side mounting allowing portion 53 that is formed by the mounting preventing transfer members 51a, 51b corresponding thereto.

Furthermore, the locking members acting when the auxiliary contact units 5a, 5b are mounted on the electromagnetic contactors 2a, 2b or the reversible unit 3 is constituted by the snap piece 40a and hook pieces 40b, 40c. Therefore, when the auxiliary contact units 5a, 5b are mounted on the electromagnetic contactors 2a, 2b or the reversible unit 3, the hook pieces 40b, 40c are always locked to the connection holes 13, 14 of the electromagnetic contactors 2a, 2b or the connection holes 3i, 3j or 3l, 3m of the reversible unit 3 and then the snap piece 40a is locked to the connection hole 12 of the electromagnetic contactors 2a, 2b or the connection hole 3h or 3k of the reversible unit 3. As a result, the auxiliary contact units 5a, 5b should be mounted obliquely, as shown in FIGS. 12(a)-12(c), and erroneous mounting can be reliably grasped.

In the abovementioned embodiments, the case is explained in which the reversible unit 3 is used as the mounting unit for an electromagnetic contactor, but such a configuration is not limiting. When a non-mountable unit that cannot be mounted on the electromagnetic contactor is present and the contactor-side mounting preventing portion is formed at the electromagnetic contactor, the mounting preventing transfer member 51a or 51b may be formed at the mounting unit for an electromagnetic contactor that is mounted between the electromagnetic contactor and the non-mountable unit.

Further, in the abovementioned embodiments, the case is explained in which the rod-shaped portion 51a of the mounting preventing transfer member 51 is formed in a quadrangular columnar shape, but such a configuration is not limited and the rod-shaped portion can be formed in another angular columnar shape or cylindrical shape or may have any cross-sectional shape. The case is also explained in which the rod-shaped portion 51a is formed linearly as a quadrangular column, but such a configuration is not limited and the rod-shaped portion can have a curved shape such as a crank shape.

Further, in the abovementioned embodiments, the case is explained in which the flat contactor-side mounting preventing portion 6f replacing the contactor-side mounting allowing portion 6e, which is the engagement depression, is formed at the electromagnetic contactors 2a, 2b where a non-mountable unit that cannot be mounted is present, but the contactor-side mounting preventing portion 6f is not necessarily a flat surface and may be a slightly receding depression or a protrusion that protrudes in the opposite direction.

Further, in the abovementioned embodiments, the case is explained in which the contactor-side mounting preventing portion 6f formed at the electromagnetic contactors 2a, 2b side is formed on a flat surface, and the unit-side mounting preventing portion 43 at the auxiliary contact units 5a, 5b side is formed by an engaging protrusion. However, this configuration is not limiting. Thus, the contactor-side mounting preventing portion 6f at the electromagnetic contactors 2a, 2b side where the non-mountable unit that cannot be mounted is present may be an engaging protrusion, and the unit-side mounting preventing portion 43 at the auxiliary contact units 5a, 5b side may be formed on the flat surface.

Further, in the abovementioned embodiments, the case is explained in which the unit-side mounting preventing portion 43 is provided close to, on the inner side of, and at a substantially central position between the hook pieces 40b, 40b, but such a configuration is not limited to such configuration, and the unit-side mounting preventing portion 43 can be formed at any position, provided that this position is within a surface that is in contact with the reversible unit 3. The positions of the contactor-side mounting preventing portion 6f of the electromagnetic contactors 2a, 2b and the mounting preventing transfer members 51a, 51b of the reversible unit 3 may be changed according to the position of the unit-side mounting preventing portion 43.

### INDUSTRIAL APPLICABILITY

The present invention can provide a mounting unit for an electromagnetic contactor that can reliably prevent mounting of a non-mountable unit that cannot be mounted on the electromagnetic contactor in a state in which the mounting unit for an electromagnetic contactor is mounted on the electromagnetic contactor and a connection structure of the electromagnetic contactor using the mounting unit.

### EXPLANATION OF REFERENCE NUMERALS

2a, 2b . . . electromagnetic contactors; 3 . . . reversible unit; 3a . . . unit main body; 3b . . . contactor mounting portion; 3c to 3f . . . snap pieces; 3g . . . unit mounting portion; 3h to 3m . . . connection holes; 4a, 4b, 5a, 5b . . . auxiliary contact units; 6 . . . main body case; 6a . . . lower case; 6b . . . upper case; 6c . . . arc-suppressing cover; 6c1 . . . level support portion; 6c2 . . . display window; 6e . . . contactor-side mounting allowing portion; 6f . . . contactor-side mounting preventing portion; 7 . . . contact portion; 7a . . . movable contact support; 7a1 . . . operation display piece; 7b . . . return spring; 7c . . . movable contact; 8 . . . electromagnet; 8a . . . coil; 8b . . . coil frame; 8c . . . fixed core; 8d . . . movable core; 9 . . . drive lever; 10 . . . terminal portion; 11 . . . coil terminal portion; 12 to 15 . . . connection holes; 31 . . . interlock mechanism; 32a, 32b . . . sliding members; 33 . . . sliding restricting member; 34 . . . rotation restricting member; 36a, 36b . . . operation display piece; 39 . . . main body case; 39a, 39b . . . unit windows; 40a . . . snap piece; 40b, 40c . . . hook pieces; 42a . . . display piece engagement portion; 43 . . . engagement protrusion; 50 . . . through hole; 51 . . . mounting preventing transfer member; 51a . . . rod-shaped portion; 51b . . . fall-out preventing portion; 52 . . . guiding groove; 53 . . . unit-side mounting allowing portion; 54 . . . unit-side mounting preventing portion

1. A mounting unit for an electromagnetic contactor mountable on the electromagnetic contactor having a contactor-side mounting preventing portion on a unit attaching portion, for preventing a mounting and engaging when mounting a non-mountable unit which is not mountable, the mounting unit comprising:
a mounting preventing transfer member formed on a unit main body, said mounting preventing transfer member forming a unit-side mounting preventing portion preventing mounting of the non-mountable unit on a unit mounting portion mounting the non-mountable unit by engaging with the contactor-side mounting preventing portion when mounted on the electromagnetic contactor.

2. A mounting unit for an electromagnetic contactor according to claim 1, wherein the mounting preventing transfer member comprises:
a rod-shaped portion inserted into a through hole formed to pass through the unit main body in a mounting direction facing the contactor-side mounting preventing portion when mounted on the electromagnetic contactor; and
a fall-out preventing portion formed to protrude in an intermediate portion of the rod-shaped portion.

3. A mounting unit for an electromagnetic contactor according to claim 2, wherein a connection hole is formed in at least one side portion of the unit attaching portion of the electromagnetic contactor,
the contactor-side mounting preventing portion is formed close to the connection hole on an inner side thereof,
a hook piece locking with the connection hole is formed to protrude in a portion for mounting on the electromagnetic contactor,
the through hole is formed close to the hook piece on the inner side thereof, and
a linking hole is formed outside of the through hole in the unit mounting portion.

4. A mounting unit for an electromagnetic contactor according to claim 1, wherein the case body is mounted over a plurality of unit attaching portions of electromagnetic contactors disposed parallel to one another and includes therein an interlock mechanism prohibiting simultaneous loading of the electromagnetic contactors.

5. A connection structure of an electromagnetic contactor comprising at least:
an electromagnetic contactor;
a mountable unit mountable on a unit attaching portion of the electromagnetic contactor; and
a non-mountable unit not mountable on the electromagnetic contactor,
wherein a contactor-side mounting preventing portion preventing erroneous mounting of the non-mountable unit is formed at the unit attaching portion of the electromagnetic contactor; and
the mountable unit includes a mounting preventing transfer member forming a unit-side mounting preventing portion preventing a mounting of the non-mountable unit on a unit mounting portion mounting the non-mountable unit by engaging with the contactor-side mounting preventing portion.
